(19) United States
(12) Patent Application Publication
(10) Pub. No.: US 2025/0224690 A1
(43) Pub. Date: Jul. 10, 2025

(54) IMAGE FORMING APPARATUS FOR BONDING PLURALITY OF SHEETS USING ADHESIVE IMAGE

(71) Applicant: CANON KABUSHIKI KAISHA, Tokyo (JP)

(72) Inventor: MASATO SAKO, Shizuoka (JP)

(21) Appl. No.: 19/008,508

(22) Filed: Jan. 2, 2025

(30) Foreign Application Priority Data
Jan. 4, 2024 (JP) 2024-000305

(51) Int. Cl. G03G 15/00

(52) U.S. Cl. CPC G03G 15/6544; G03G 15/6573; G03G 2215/00666; G03G 2215/00772; G03G 2215/00835

(57) ABSTRACT

An image forming apparatus includes an image forming unit configured to form an image including an adhesive image by powder adhesive on a sheet that is conveyed; a bonding unit, to which sheets on which the image has been formed by the image forming unit are conveyed in order, configured to, by heating a plurality of sheets conveyed to and stacked in the bonding unit, bond the plurality of sheets, using adhesive images formed on the plurality of sheets; and a control unit configured to evaluate a temperature of the plurality of sheets conveyed to the bonding unit and, based on the evaluated temperature, control an amount of heat to be applied to the plurality of sheets by the bonding unit heating the plurality of sheets.

### BACKGROUND

### Field of the Disclosure

The present disclosure relates to an image forming apparatus that uses powder adhesive.

### Description of the Related Art

Image forming apparatuses that create a booklet by forming an image on a plurality of sheets and then performing stapling processing on the sheets on which an image has been formed are used. In the stapling processing, metal staples are used. Meanwhile, Japanese Patent Laid-Open No. 2004-209859 discloses a configuration in which, by sheets being bonded to each other using powder adhesive, a booklet is created without using metal staples. According to Japanese Patent Laid-Open No. 2004-209859, toner is used as powder adhesive.

In order to bond sheets to each other using powder adhesive, it is necessary to heat sheets to which powder adhesive has been applied, and thus, power consumption increases as compared with that of the stapling processing.

### SUMMARY

According to an embodiment of the present disclosure, an image forming apparatus includes an image forming unit configured to form an image including an adhesive image by powder adhesive on a sheet that is conveyed; a bonding unit, to which sheets on which the image has been formed by the image forming unit are conveyed in order, configured to, by heating a plurality of sheets conveyed to and stacked in the bonding unit, bond the plurality of sheets, using adhesive images formed on the plurality of sheets; and a control unit configured to evaluate a temperature of the plurality of sheets conveyed to the bonding unit and, based on the evaluated temperature, control an amount of heat to be applied to the plurality of sheets by the bonding unit heating the plurality of sheets.

Further features of various embodiments will become apparent from the following description of exemplary embodiments with reference to the attached drawings.

### BRIEF DESCRIPTION OF THE DRAWINGS

FIG. 1 is a schematic diagram of a configuration of an image forming apparatus according to some embodiments.

FIG. 2 is a schematic diagram of a configuration of a thermocompression bonding unit according to some embodiments.

FIGS. 3A to 3C are diagrams illustrating examples of an adhesive image.

FIG. 4A is a diagram illustrating an example of measuring adhesive strength.

FIG. 4B is a diagram illustrating an example of a relationship between pre-processing temperature and heating temperature.

FIGS. 5A and 5B are diagrams illustrating thermal conduction models according to one embodiment.

FIG. 6 is a diagram illustrating an example of a relationship between the temperature of a pressing roller and pre-processing temperature.

FIG. 7A is a diagram illustrating adhesive images formed on a plurality of sheets.

FIG. 7B is a diagram illustrating an example of a change in the temperature of each adhesive image.

FIG. 8 is a flowchart for bonding processing according to some embodiments.

FIG. 9 is a diagram illustrating an example of power consumption according to one embodiment.

FIG. 10A is a diagram illustrating an example of a relationship between the temperature of a pressing roller and pre-processing temperature.

FIG. 10B is a diagram illustrating an example of a relationship between the temperature of a heating film and pre-processing temperature.

FIG. 11 is a diagram illustrating an example of power consumption according to one embodiment.

FIGS. 12A and 12B are diagrams illustrating thermal conduction models according to one embodiment.

FIG. 13A is a diagram illustrating an example of a relationship between the temperature of a pressing roller and pre-processing temperature.

FIG. 13B is a diagram illustrating an example of a relationship between the temperature of a secondary transfer roller and pre-processing temperature.

FIG. 13C is a diagram illustrating an example of a relationship between the temperature of a conveyance path and pre-processing temperature.

FIG. 14 is a diagram illustrating an example of power consumption according to one embodiment.

FIG. 15A is a diagram illustrating an example of a relationship between the temperature of a pressing roller and pre-processing temperature.

FIG. 15B is a diagram illustrating an example of a relationship between environmental temperature and pre-processing temperature.

FIG. 16 is a diagram illustrating an example of power consumption according to one embodiment.

FIG. 17A is a diagram illustrating an example of a relationship between the temperature of a pressing roller and pre-processing temperature.

FIG. 17B is a diagram illustrating an example of a relationship between processing speed and pre-processing temperature.

FIG. 18 is a diagram illustrating an example of power consumption according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### First Embodiment

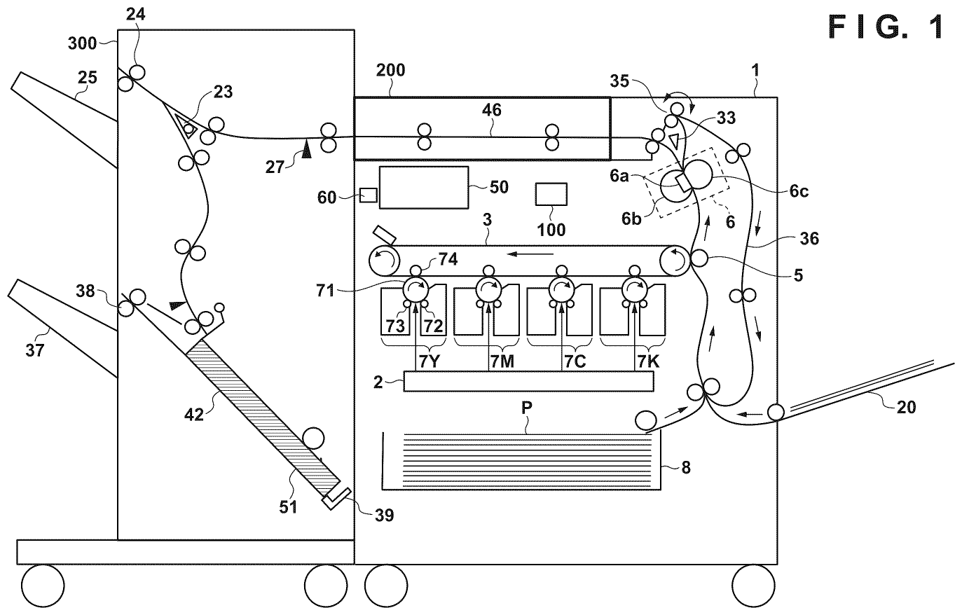

FIG. 1 is a diagram of a configuration of an image forming apparatus 1 according to the present embodiment. The image forming apparatus 1 includes forming units 7Y, 7M, 7C, and 7K that respectively store yellow, magenta, cyan, and black toners and form yellow, magenta, cyan, and black toner images. In the following description, it is assumed that black toner is used as powder adhesive. Regarding the black toner, a configuration may be taken so as to use it only for bonding sheets to each other, or a configuration may be taken so as to use it both for bonding sheets to each other and forming a black toner image. When black toner is used only for bonding sheets to each other, a black color in an image to be formed on a sheet may be formed by superimposing yellow, magenta, and cyan toners. The color of toner to be used as powder adhesive may be different from black. Further, the number of colors of toner to be used as powder adhesive may be 2 or more. Further, when the forming unit 7K is used only for bonding sheets to each other, the forming unit 7K may be configured to store, for example, powder adhesive that is of any color or transparent, instead of black toner. Further, a configuration may be taken so as to provide a fifth forming unit to be used for bonding sheets to each other and store powder adhesive that is of any color or transparent in that forming unit.

The configurations of the forming units 7Y, 7M, 7C and 7K are similar and include a photosensitive body 71, a charging roller 72, a developing roller 73, and a primary transfer roller 74. In the following description, when the forming units 7Y, 7M, 7C and 7K are collectively referred to, they will be referred to as the forming units 7. The photosensitive body 71 is rotationally driven in a clockwise direction in the figure at the time of image formation. The charging roller 72 charges the photosensitive body 71 to a uniform potential. A scanner unit 2 exposes each photosensitive body 71 to form an electrostatic latent image on each photosensitive body 71. An electrostatic latent image includes an electrostatic latent image for adhesion and an electrostatic latent image not for adhesion. The developing roller 73 develops the electrostatic latent image on the photosensitive body 71 using toner (or powder adhesive) to form a toner-based (or powder adhesive-based) image on the photosensitive body 71. An image formed on the photosensitive body 71 by development includes an image for adhesion and an image not for adhesion. In the following description, an image for adhesion is referred to as an adhesive image.

The primary transfer rollers 74 transfer the images formed on respective photosensitive bodies 71 to an intermediate transfer body 3, which is rotationally driven in a counterclockwise direction in the figure. The images transferred to the intermediate transfer body 3 by rotation of the intermediate transfer body 3 are conveyed to a position facing a secondary transfer roller 5. The second transfer roller 5 may be referred to as a transfer unit. The transfer unit may include the intermediate transfer body. The secondary transfer roller 5 transfers the images on the intermediate transfer body 3 to a sheet P that has been conveyed from a cassette 8 or a tray 20 along a conveyance path.

A fixing device 6 performs fixing processing for fixing the images to the sheet P by heating and pressing the sheet P to which the images have been transferred. The fixing device 6 includes a heating film 6b which is a heating member, a ceramic heater 6a which is a heat source of the heating film 6b, and a pressing roller 6c which is a pressing member. Further, the fixing device 6 includes a temperature sensor (not illustrated) that measures the surface temperature of the heating film 6b, such as a radiation thermometer. The sheet P is heated by the heating film 6b and is pressed by the pressing roller 6c while passing through a nip region between the heating film 6b and the pressing roller 6c. In the following description, the nip region between the heating film 6b and the pressing roller 6c of the fixing device 6 will simply be referred to as the “nip region” of the fixing device 6.

The forming units 7Y, 7M, 7C and 7K, the scanner unit 2, the intermediate transfer body 3, the secondary transfer roller 5, and the fixing device 6 form an image forming unit that forms an image on a conveyed sheet P.

When forming an image only on one side (front surface) of a sheet P, the sheet P which has passed through the fixing device 6 is conveyed to an intermediate conveyance unit 200 by a flapper 33. When forming an image on both sides of a sheet P, the sheet P on which an image has been formed on the first surface (front surface), after passing through the fixing device 6, is conveyed to a reversing roller 35 by the flapper 33 and then to a double-sided conveyance path 36 by the reversing roller 35. The sheet P conveyed to the double-sided conveyance path 36 is conveyed to the position facing the secondary transfer roller 5 again, and an image is formed on a second surface (back surface). The sheet P on which an image has been formed on both sides passes through the fixing device 6 and is then conveyed to the intermediate conveyance unit 200 by the flapper 33.

A sheet P conveyed to the intermediate conveyance unit 200 is conveyed to a post-processing apparatus 300 along a conveyance path 46. In the case of a sheet P not to be subjected to bonding processing, the sheet P is discharged to a discharge tray 25 by discharge rollers 24. When performing processing for bonding sheets P, after the trailing end of a sheet P has passed through the position of a flapper 23, the discharge rollers 24 are rotated in a direction opposite to that thus far, and the sheet P is thereby conveyed to a thermocompression bonding unit 51. At that time, the flapper 23 is set in an orientation for guiding the sheet P to the thermocompression bonding unit 51.

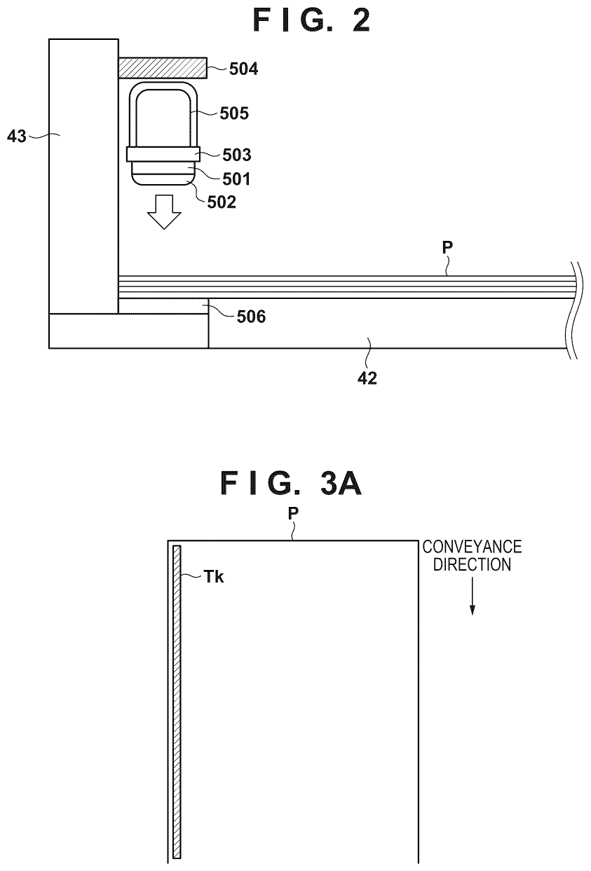

The thermocompression bonding unit 51 functions as a bonding unit that performs bonding processing on sheets P. A plurality of sheets P to be subjected to the bonding processing are stacked in order on an intermediate stacking unit 42 of the thermocompression bonding unit 51. The plurality of sheets P stacked on the intermediate stacking unit 42 are subjected to alignment processing by a vertical alignment reference plate 39 and a horizontal alignment reference plate 43 (FIG. 2). After alignment processing, processing for bonding the plurality of sheets P stacked on the intermediate stacking unit 42 is performed.

FIG. 2 is a cross-sectional diagram of the thermocompression bonding unit 51 when viewed from the vertical alignment reference plate 39 of FIG. 1 in a direction opposite to a conveyance direction of a sheet P. An aluminum heating plate 502 is heated by a ceramic heater 501, which is a heating source. The ceramic heater 501 is supported by a resin heater support 503. By a pressing lever 504 pressing down the heating plate 502 via a metal stay 505, the heating plate 502 heats and presses sheets P stacked on the intermediate stacking unit 42. A receiving member 506 for stably receiving pressing force is provided in a region on the intermediate stacking unit 42 side corresponding to a region of sheets P to be pressed by the heating plate 502. The receiving member 506 is constituted by, for example, silicon rubber. An adhesive image is provided in a region of a sheet P to be heated and pressed by the heating plate 502.

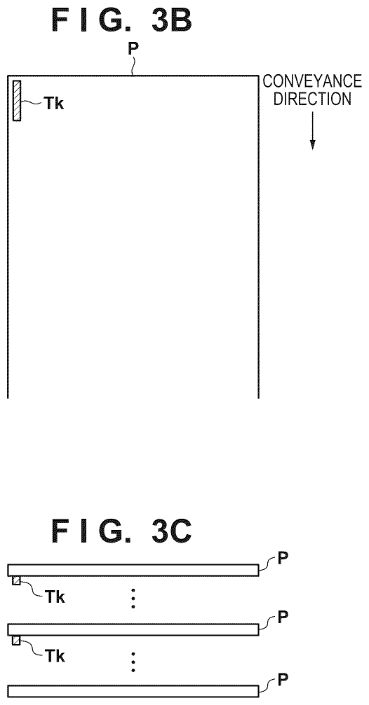

FIG. 3A illustrates an adhesive image Tk formed on a sheet P. As illustrated in FIG. 3A, the adhesive image Tk is formed along one of the two sides of the sheet P that is parallel to the conveyance direction of the sheet P. With this, it is possible to form a side-bound booklet. Further, as illustrated in FIG. 3B, an adhesive image Tk may be formed along one section of one of the two sides of a sheet P that is parallel to the conveyance direction of the sheet P. With this, it is possible to form a corner-bound booklet. In the present embodiment, as illustrated in FIG. 3C, an adhesive image Tk is formed on one surface (e.g., only on the first surface) of a sheet P that is stacked on the intermediate stacking unit 42. Therefore, as illustrated in FIG. 3C, no adhesive image Tk is formed on a sheet P positioned at one of the two ends of a booklet. A configuration may be taken so as to form an adhesive image Tk on all surfaces to be bonded to another sheet P.

Returning to FIG. 1, after the bonding processing by the thermocompression bonding unit 51 has been completed, a booklet constituted by a plurality of bonded sheets P is pushed to discharge rollers 38 by a bundle discharge guide (not illustrated) and is discharged to a discharge tray 37 by the discharge rollers 38.

A control unit 100 includes a volatile and/or non-volatile memory and one or more processors. The one or more processors control the entire image forming apparatus 1 by executing a control program stored in the memory. For example, the control unit 100 controls power supplied to the ceramic heater 6a based on the surface temperature of the heating film 6b measured by the temperature sensor of the fixing device 6 such that the surface temperature of the heating film 6b reaches a target temperature. Further, the control unit 100 controls bonding processing by the thermocompression bonding unit 51. Further, the control unit 100 controls the temperature and duration of heating by the heating plate 502 in the bonding processing. In addition to the control program, the memory also stores various kinds of control data to be used in the control of the image forming apparatus 1. A temperature sensor 60 is provided in a position not affected by heat generation of the fixing device 6 and detects temperature (hereinafter, environmental temperature) around the image forming apparatus 1, and outputs a signal indicating the detected environment temperature to the control unit 100. An operation unit 50 provides an input/output interface to a user.

In the present embodiment, the bonding processing by the thermocompression bonding unit 51 is performed in units of N sheets (where N is an integer of 2 or more), which is a predetermined number. That is, when creating one booklet with M sheets P (where M is an integer of 2 or more), which is N or less sheets, the thermocompression bonding unit 51 performs the bonding processing once M sheets P are stacked on the intermediate stacking unit 42 and thereby creates one booklet. Meanwhile, when M is more than N, the thermocompression bonding unit 51 performs the bonding processing every time N sheets P are newly stacked on the intermediate stacking unit 42 and when the last sheet P of M sheets P constituting one booklet is loaded on the intermediate stacking unit 42. In the following description, N is 5 as an example. Therefore, if M=12, when the first to fifth sheets P are stacked on the intermediate stacking unit 42, the thermocompression bonding unit 51 performs the first bonding processing. Then, when the sixth to 10th sheets P are stacked on the fifth sheet P, which has been subjected to the previous bonding processing, the thermocompression bonding unit 51 performs the second bonding processing. Further, when the 11th to 12th sheets P are stacked on the 10th sheet P, the thermocompression bonding unit 51 performs the third bonding processing. In the following description, 1 to N sheets (5 sheets in this example) to be subjected to the bonding processing will be referred to as a processing target sheet bundle. For example, when creating one booklet with 12 sheets, the first to fifth sheets P are one processing target sheet bundle, the sixth to 10th sheets P are one processing target sheet bundle, and the 11th and 12th sheets are one processing target sheet bundle.

In the present embodiment, in order to reduce power consumption in bonding processing, the amount of heat that the heating plate 502 applies to sheets P in the bonding processing is appropriately controlled. As a method of controlling the amount of heat that the heating plate 502 applies to sheets P, there are a method of controlling the temperature of heating by the heating plate 502, a method of controlling the duration of heating by the heating plate 502, and a method of controlling both the temperature and duration of heating by the heating plate 502. In the following description, as an example, it is assumed that the duration of heating by the heating plate 502 is fixed to two seconds, and the amount of heat to be applied to sheets P is controlled by controlling the heating temperature. When the heating temperature is fixed, if the heating duration increases, the amount of heat to be applied to sheets P increases. Similarly, when the heating duration is fixed, if the heating temperature increases, the amount of heat to be applied to sheets P increases.

Next, for understanding of the embodiment, results of each experiment conducted by the inventor will be described. In the experiments to be described below, Canon Inc.'s RedLabelPresentation (A4 size) was used as a sheet P. Further, in the following description, when distinguishing a plurality of sheets P stacked on the intermediate stacking unit 42, the order in which they were conveyed to the intermediate stacking unit 42 will be used. That is, the first sheet P is a sheet P that was first conveyed to the intermediate stacking unit 42, that is, a sheet P that is in contact with the receiving member 506 of FIG. 2.

### (Relationship Between Sheet Temperature at Time of Bonding Processing and Adhesion)

An experiment on a relationship between the temperature of sheets P at the time of performing the bonding processing and adhesion was carried out. In the experiment, five sheets P were stacked on the intermediate stacking unit 42, and the bonding processing was immediately performed by the thermocompression bonding unit 51, while changing the temperature of heating by the heating plate 502 and the temperature of sheets P to be stacked on the intermediate stacking unit 42. As described above, the heating duration in the thermocompression bonding unit 51 was 2 seconds.

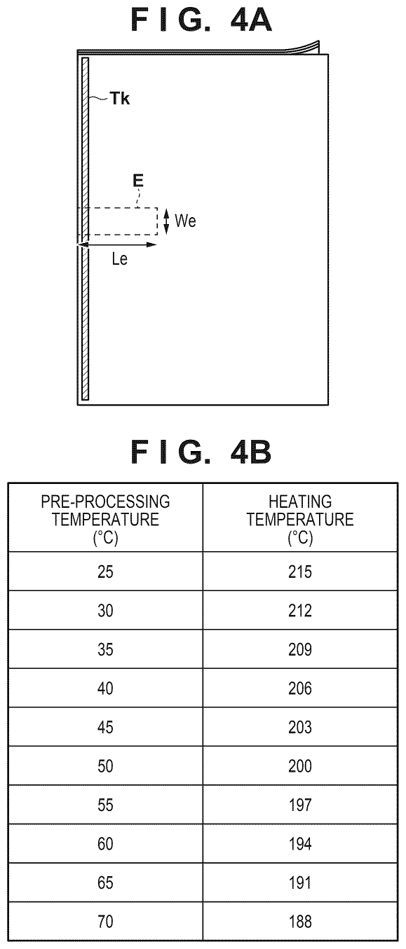

After the bonding processing, as illustrated in FIG. 4A, a portion with a length We=20 mm in the conveyance direction and a length Le=50 mm in a width direction perpendicular to the conveyance direction was cut out as a test piece E from a booklet formed by the bonding processing. Then, a strength for when the first and second sheets of the test piece are separated by holding the first sheet P of the test piece E and pulling the second to fifth sheets P upward was measured as adhesive strength using a digital force gauge. Nippon Densan Shimpo Co., Ltd's FGP-2 was used as the digital force gauge. The reason for assuming the strength for when the first and second sheets of the test piece are separated as adhesive strength is that an adhesive image Tk between the first and second sheets among four adhesive images Tk for bonding five sheets P is the farthest from the heating plate 502. That is, it is most difficult to increase the temperature of the adhesive image Tk between the first and second sheets.

Regarding adhesive strength, 0.5 N/cm or more per unit distance of the test piece E in the conveyance direction was set to be passing, taking into account actual applications. FIG. 4B indicates the results of the experiment. “Pre-processing temperature” of FIG. 4B is the temperature of sheets P before the bonding processing, and “heating temperature” indicates the heating temperature at which the adhesive strength was 0.5 N/cm or more. According to FIG. 4B, when the pre-processing temperature increases, the heating temperature necessary for maintaining the adhesive strength decreases. More specifically, according to the experiment results of FIG. 4B, the relationship between a heating temperature Tg and a pre-processing temperature Ta is expressed by Equation 1 below.

$$Tg = - 0.6 Ta + 230 \qquad ( Equation 1 )$$

As described above, the higher the temperature of sheets P before performing the bonding processing, the lower the temperature of the heating plate 502 can be.

### (Estimation of Temperature of Pressing Roller at Time of Fixing)

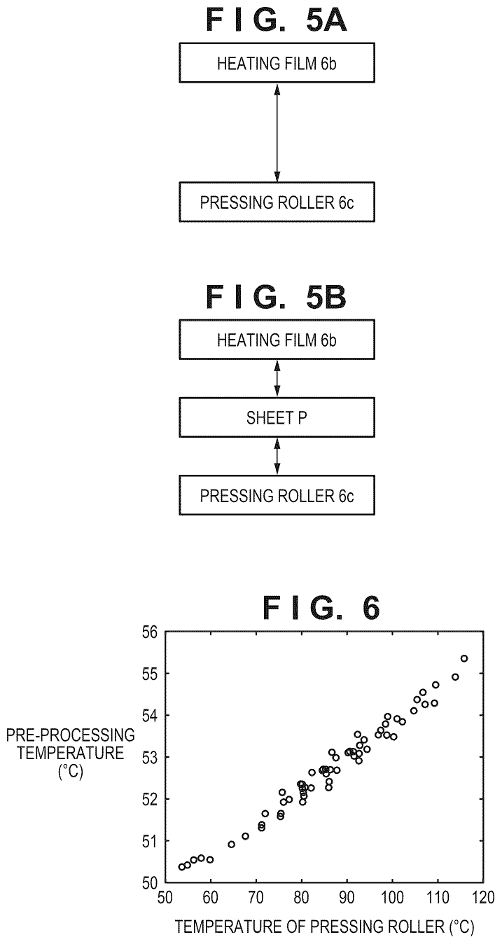

In the present embodiment, the temperature of the pressing roller 6c during the fixing processing for a sheet P is estimated, and this is used as an evaluation value for the pre-processing temperature of sheets P. First, a method of estimating the temperature of the pressing roller 6c will be described. FIGS. 5A and 5B illustrate a thermal conduction model for estimating the temperature of the pressing roller 6c. FIG. 5A is a model for when the fixing processing for the sheet P is not being performed, and FIG. 5B is a model for when the fixing processing for the sheet P is being performed. In the following description, it is assumed that the temperatures of the pressing roller 6c and the heating film 6b at time t are Tr(t) and Tf(t), respectively.

The temperature Tr(t) of the pressing roller 6c at time t when the fixing processing is not being performed is estimated based on the following difference equation.

$$\{ Tr ( t ) - Tr ( t - Δ t ) \} / Δ t = A 1 \{ Tf ( t - Δ t ) - Tr ( t - Δ t ) \} \qquad ( Equation 2 )$$

In Equation 2, Δt is an estimation period and is, for example, 20 ms. The coefficient A1 is a positive value and is determined by experimentation. According to Equation 2, when the temperature of the heating film 6b is higher than the temperature of the pressing roller 6c at time (t−Δt), the temperature of the pressing roller 6c at time t is higher than that of time (t−Δt). While the fixing processing is not being performed, the control unit 100 can estimate the temperature Tr(t) of the pressing roller 6c based on the temperature of the heating film 6b obtained from the temperature sensor of the fixing device 6. An initial temperature at the start of estimation of the temperature Tr(t) of the pressing roller 6c may be, for example, a predetermined value or an environmental temperature measured by the temperature sensor 60.

The temperature Tr(t) of the pressing roller 6c at time t when the fixing processing is being performed is estimated based on the following difference equation.

$$\{ Tr ( t ) - Tr ( t - Δ t ) \} / Δ t = A 2 \{ Tr ( t - Δ t ) - Tp \} \qquad ( Equation 3 )$$

In Equation 3, Tp is the temperature of a sheet P and, in the present example, is set to a predetermined value, for example, 23° C. The temperature Tp of the sheet P may be the environmental temperature measured by the temperature sensor 60. The coefficient A2 is a negative value and is determined by experimentation. According to Equation 3, when the temperature of the pressing roller 6c is higher than the temperature of the sheet P at time (t−Δt), the temperature of the pressing roller 6c at time t is less than that of time (t−Δt). When the fixing processing is started, the control unit 100 estimates the temperature Tr(t) of the pressing roller 6c based on Equation 3. The temperature Tr(t) of the pressing roller 6c at the start of the fixing processing is based on Equation 2.

When starting image formation according to a print job, the fixing device 6 performs start-up processing including starting heating of the heating film 6b. In the start-up processing, the temperature of the pressing roller 6c increases due to the heat of the heating film 6b. During the fixing processing, since a sheet P steals the heat of the pressing roller 6c, the temperature of the pressing roller 6c decreases. However, it takes about one hour for the temperature of the pressing roller 6c, which had been heated by print processing, to decrease to around room temperature. Therefore, when repeating creation of a booklet in a relatively short time, the temperature of the pressing roller 6c gradually increases.

### (Relationship Between Temperature of Pressing Roller 6c and Pre-Processing Temperature)

An experiment on a relationship between the temperature Tr of the pressing roller 6c estimated using the above Equations 2 and 3 and the pre-processing temperature Ta was carried out. First, an experiment in which three booklets, each with five sheets P, were created every five seconds was carried out four times in total. At that time, the temperature of sheets P conveyed to the thermocompression bonding unit 51 was measured by a non-contact temperature sensor. At the start of each round, the temperature of the pressing roller 6c was set to 23° C., which is room temperature. In addition, durations (hereinafter, referred to as start-up durations) of the start-up processing of the fixing device 6 in the first, second, third, and fourth rounds were set to 5 seconds, 7.5 seconds, 10 seconds and 20 seconds, respectively.

FIG. 6 illustrates the results of the above experiment. According to FIG. 6, it can be seen that the estimated temperature Tr of the pressing roller and the pre-processing temperature Ta of sheets P have a positive correlation. That is, the higher the estimated temperature Tr of the pressing roller, the higher the pre-processing temperature Ta. In the results of FIG. 6, the relationship between the temperature Tr of the pressing roller and the pre-processing temperature Ta is as follows.

$$Ta = 0.0 \; 789 Tr + 45.9 \qquad ( Equation 4 )$$

### (Adhesive Strength Between Plurality of Sheets)

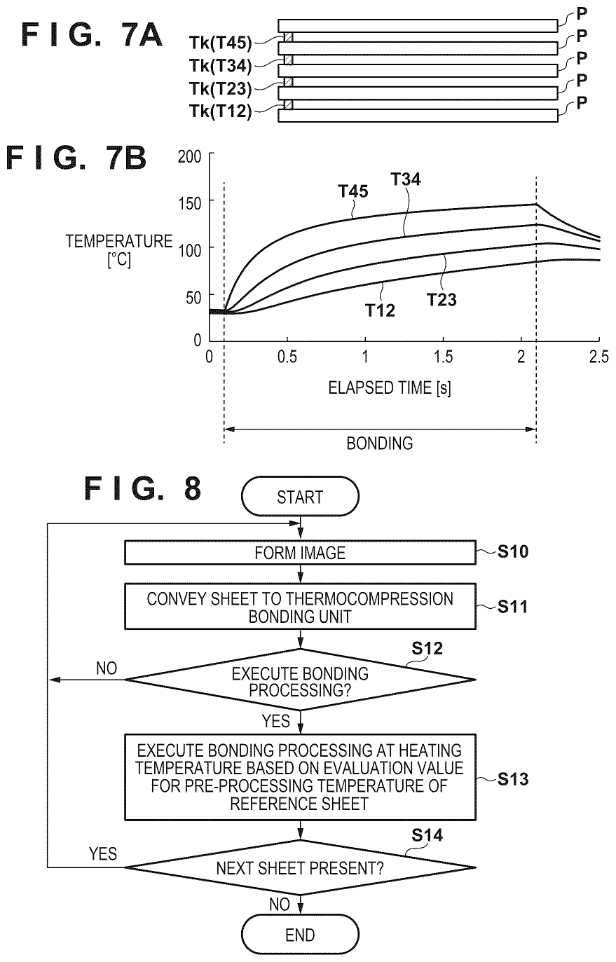

As described in the explanation of FIGS. 4A and 4B, in the present embodiment, the strength for when the first sheet P and the second sheet P are separated is set as the adhesive strength. An experiment was carried out to verify the validity thereof. First, as illustrated in FIG. 7A, an adhesive image that bonds an n-th sheet P (where n is an integer from 1 to 4) and an (n+1)-th sheet P will be denoted as Tn(n+1). The initial temperature of each sheet P was set to 23° C., the sheets P were only heated for two seconds by the heating plate 502 at 200° C., and the temperature of the adhesive image Tn(n+1) was measured. FIG. 7B illustrates the results of the experiment. According to FIG. 7B, the temperature of an adhesive image T12 for bonding the first sheet P and the second sheets P is the lowest.

### (Temperature Control of Thermocompression Bonding Unit 51)

Based on the above experiment, in the present embodiment, the temperature (pre-processing temperature) before the processing for bonding N or less sheets (in this example, five sheets) constituting the processing target sheet bundle is evaluated, and the heating temperature in the bonding processing is controlled based on the evaluated temperature. Here, as the pre-processing temperature of the processing target sheet bundle, the pre-processing temperature of a sheet P (hereinafter, referred to as a reference sheet) in the farthest position from the heating plate 502 among the N or less sheets constituting one processing target sheet bundle is used. In this example, the reference sheet is a sheet P conveyed to the thermocompression bonding unit 51 first among the N or less sheets constituting one processing target sheet bundle. Further, in the present embodiment, the pre-processing temperature of the reference sheet is evaluated based on the temperature Tr of the pressing roller 6c during execution of the fixing processing for the reference sheet. The temperature Tr of the pressing roller 6c to be used as the evaluation value for the pre-processing temperature of the reference sheet may be the temperature Tr of the pressing roller 6c at a predetermined timing during execution of the fixing processing for the reference sheet. As an example, the predetermined timing may be a timing at which the fixing processing for the reference sheet is completed, that is, a timing at which the trailing end of the reference sheet passes through the nip region of the fixing device 6. Also, the temperature Tr of the pressing roller 6c to be used as the evaluation value for the pre-processing temperature of the reference sheet may be a statistical value, such as an average value, obtained based on the temperature Tr of the pressing roller 6c during execution of the fixing processing for the reference sheet.

FIG. 8 is a flowchart related to bonding processing according to the present embodiment. The processing of FIG. 8 is started by reception of a print job that involves bonding processing. The control unit 100, in step S10, forms an image on a sheet P and, in step S11, conveys the sheet P on which an image has been formed to the thermocompression bonding unit 51. In step S12, the control unit 100 determines whether a condition for executing the bonding processing is satisfied. In the present embodiment, the condition for executing the bonding processing is satisfied when five sheets P are newly conveyed to the thermocompression bonding unit 51. In this case, the number of sheets of a processing target sheet bundle is five. The condition for executing the bonding processing is satisfied also when it is the last sheet in the print job. In this case, the number of sheets of a processing target sheet bundle may be one of one to four sheets. If the condition for executing the bonding processing is not satisfied, the control unit 100 repeats the processing from step S10. Meanwhile, if the condition for executing the bonding processing is satisfied, the control unit 100 executes the bonding processing in step S13. At this time, the control unit 100 controls the heating temperature in the bonding processing, that is, the temperature of the heating plate 502, based on the evaluation value for the pre-processing temperature of the reference sheet. Further, in the present embodiment, the evaluation value for the pre-processing temperature of the reference sheet is the temperature Tr of the pressing roller 6c during the fixing processing for the reference sheet. In step S14, the control unit 100 determines whether the print job is completed and, if it is not completed, repeats the processing from step S10. Meanwhile, if the print job is completed, the control unit 100 ends the processing of FIG. 8.

### Comparison

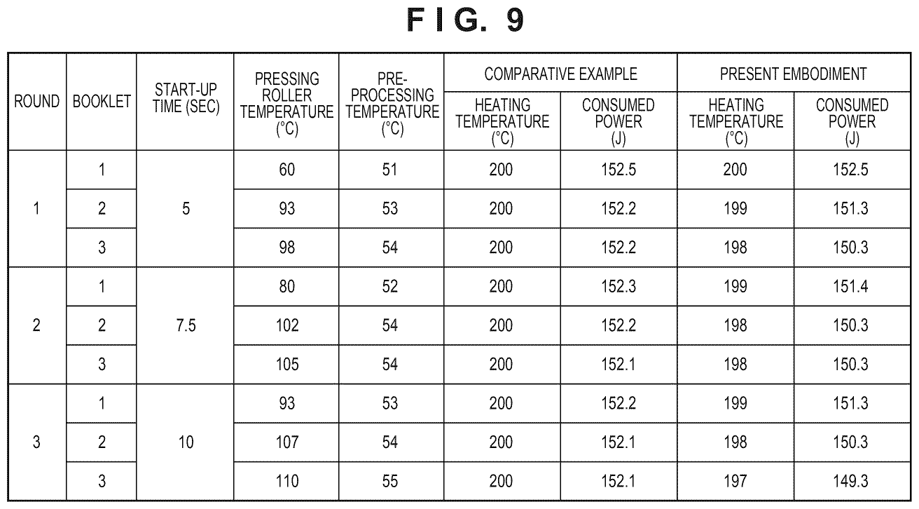

FIG. 9 illustrates an example of comparison of a case where the heating temperature in the bonding processing is set to be fixed and a case where the heating temperature in the bonding processing was controlled based on the details described in the present embodiment. An experiment in which three booklets, each with five sheets P, were created every five seconds was carried out three times in total. At the start of each round, the temperature of the pressing roller 6c was set to 23° C., which is room temperature. In addition, the start-up durations of the fixing device 6 in the first, second and third rounds are 5 seconds, 7.5 seconds and 10 seconds, respectively. As described above, the duration of heating by the heating plate 502 was 2 seconds. The power consumption was calculated by measuring the power consumption [W] of the thermocompression bonding unit 51 by connecting a power meter to the ceramic heater 501, and integrating the measured power consumptions [W] over the heating duration (2 seconds). The heating temperature in the comparative example was set to 200° C.

The pressing roller temperature of FIG. 9 indicates the temperature Tr of the pressing roller 6c estimated at a timing at which the fixing processing for the reference sheet is completed. Further, the pre-processing temperature of FIG. 9 indicates the pre-processing temperature obtained according to Equation 4 from the temperature Tr of the pressing roller 6c. As illustrated in FIG. 9, as the temperature Tr of the pressing roller 6c increases, that is, as the evaluation result of the pre-processing temperature increases, the control unit 100 decreases the heating temperature. Therefore, it is possible to reduce power consumption in the bonding processing.

A configuration may be taken so as to store, for example, determination information for determining the heating temperature based on the pre-processing temperature of the reference sheet, in advance in the control unit 100. The determination information in this case may indicate, for example, a relationship between the pre-processing temperature and the heating temperature as indicated in Equation 1. The control unit 100 obtains the pre-processing temperature according to, for example, Equation 4, based on the estimated temperature Tr of the pressing roller 6c and sets the heating temperature by referencing the determination information based on the obtained pre-processing temperature. Also, a configuration may be taken so as to store, in advance in the control unit 100, determination information for determining the heating temperature based on the temperature Tr of the pressing roller 6c. The determination information in this case may indicate a relationship between the temperature Tr of the pressing roller 6c and the heating temperature, and may be obtained, for example, based on Equations 1 and 4. The control unit 100 sets the heating temperature by referencing the determination information based on the estimated temperature Tr of the pressing roller 6c. The temperature of the reference sheet may decrease in a duration from when the reference sheet is conveyed to the thermocompression bonding unit 51 until when the bonding processing is performed. Therefore, the determination information may be created considering this temperature drop in the reference sheet.

Since the temperature of the fixing roller 6c increases as the start-up duration of the fixing device 6 increases, a configuration may be taken so as to decrease the heating temperature as the start-up duration increases. Further, a configuration may be taken as to as measure the temperature Tr of the fixing roller 6c for when the fixing processing for the reference sheet is being performed and the temperature of the reference sheet conveyed to the thermocompression bonding unit 51 using a non-contact temperature sensor and control the heating temperature of the bonding processing based on the measured values.

Further, a configuration may be taken so as to, instead of measuring the temperature of the reference sheet conveyed to the thermocompression bonding unit 51, measure the temperature of the reference sheet, on which the fixing processing has been performed by the fixing device 6, while being conveyed from the fixing device 6 to the thermocompression bonding unit 51. Similarly, a configuration may be taken so as to, instead of estimating the temperature of the reference sheet conveyed to the thermocompression bonding unit 51 using Equation 1 or the like, estimate the temperature of the reference sheet being conveyed in a predetermined position between the fixing device 6 and the thermocompression bonding unit 51. This is based on the pre-processing temperature of the sheet P increasing as the temperature of the sheet P at any position between the fixing device 6 and the thermocompression bonding unit 51 increases.

Further, in the present embodiment, the pre-processing temperature of the first sheet P in a processing target sheet bundle is assumed as the pre-processing temperature of the processing target sheet bundle, but a configuration may be taken so as to use the pre-processing temperature of another sheet P in the processing target sheet bundle. For example, when the first sheet P is heated by preheating the receiving member 506 by the heating plate 502 while there is no sheet P in the thermocompression bonding unit 51, the temperature of the adhesive image T23 may be lower than that of the adhesive image T12 of FIG. 7A. In such a case, the second sheet P may be set as the reference sheet. That is, the reference sheet can be determined according to the configuration of the thermocompression bonding unit 51. In addition, when taking into account the respective pre-processing temperatures of sheets P included in a processing target sheet bundle, a value obtained based on the respective pre-processing temperatures of the sheets P included in the processing target sheet bundle can be set as the pre-processing temperature of the processing target sheet bundle.

Although the temperature Tr of the pressing roller 6c is estimated according to the thermal conduction models illustrated in FIGS. 5A and 5B, the present embodiment is not limited to estimating the temperature Tr of the pressing roller 6c according to the thermal conduction models illustrated in FIGS. 5A and 5B, and any thermal conduction model can be used.

### Second Embodiment

Next, a second embodiment will be described focusing on differences from the first embodiment. In the first embodiment, the temperature Tr of the pressing roller 6c is assumed as an evaluation value for the pre-processing temperature. In the present embodiment, in addition to the temperature Tr of the pressing roller 6c, the temperature Tf of the heating film 6b is used.

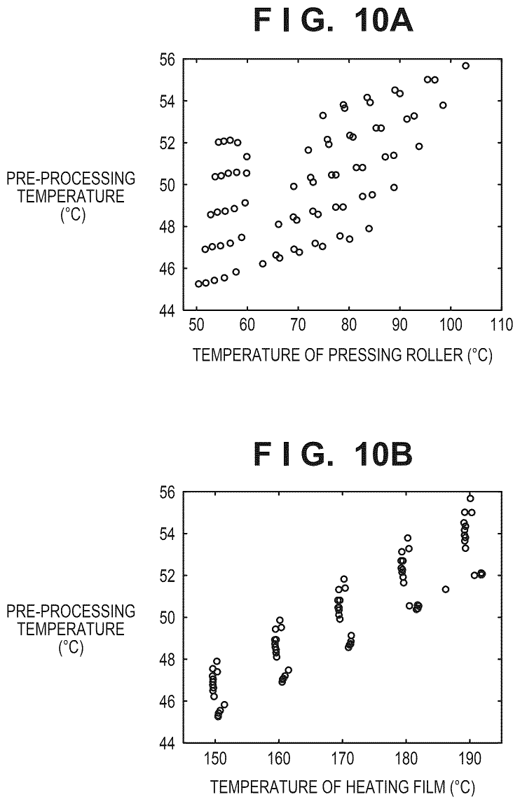

The control unit 100 controls the temperature Tf of the heating film 6b according to the type of a sheet P, the amount of toner on the sheet P, and the like. The amount of heat that a sheet P receives from the heating film 6b when the sheet P passes through the fixing device 6 changes due to the change in temperature Tf of the heating film 6b, and thus, the temperature of the sheet P also changes. FIGS. 10A and 10B illustrate the results of an experiment in which the pre-processing temperature was measured while changing the temperature of the heating film 6b. In the experiment, an experiment in which three booklets, each with five sheets P, were created every five seconds was carried out four times in total. At the start of each round, the temperature of the pressing roller 6c was set to 23° C., which is room temperature. In addition, the temperatures of the heating film 6b in the first, second, third and fourth rounds were set to 150° C., 160° C., 170° C., and 180° C., respectively. The other conditions were the same in each round.

FIG. 10A illustrates a relationship between the temperature Tr of the pressing roller estimated at a timing at which the fixing processing for the reference sheet was completed and the pre-processing temperature. FIG. 10B illustrates a relationship between the temperature Tf of the heating film at a timing at which the fixing processing for the reference sheet was completed and the pre-processing temperature. Based on the results of FIGS. 10A and 10B, the pre-processing temperature Ta is determined based on Equation 5 below.

$$Ta = 0.0 \; 84 Tr + 0.1 \; 54 Tf + 17.8 \qquad ( Equation 5 )$$

A flowchart related to boding processing according to the present embodiment is similar to that of FIG. 8. However, evaluation values for the pre-processing temperature of the reference sheet in step S13 are the temperature Tr of the pressing roller 6c and the temperature Tf of the heating film 6b. The temperature of the heating film 6b to be used as an evaluation value for the pre-processing temperature of the reference sheet is the temperature Tf of the heating film 6b at a predetermined timing during execution of the fixing processing for the reference sheet. As an example, the predetermined timing may be a timing at which the fixing processing for the reference sheet is completed, that is, a timing at which the trailing end of the reference sheet passes through the nip region of the fixing device 6. Also, the temperature of the heating film 6b to be used as an evaluation value for the pre-processing temperature of the reference sheet may be a statistical value, such as an average value, obtained based on the temperature of the heating film 6b during execution of the fixing processing for the reference sheet.

In the present embodiment, the pre-processing temperature can be accurately estimated even when the temperature of the heating film 6b is changed, and therefore, the amount of heat in the bonding processing can be appropriately controlled. Therefore, it is possible to reduce power consumption in the bonding processing.

### Comparison

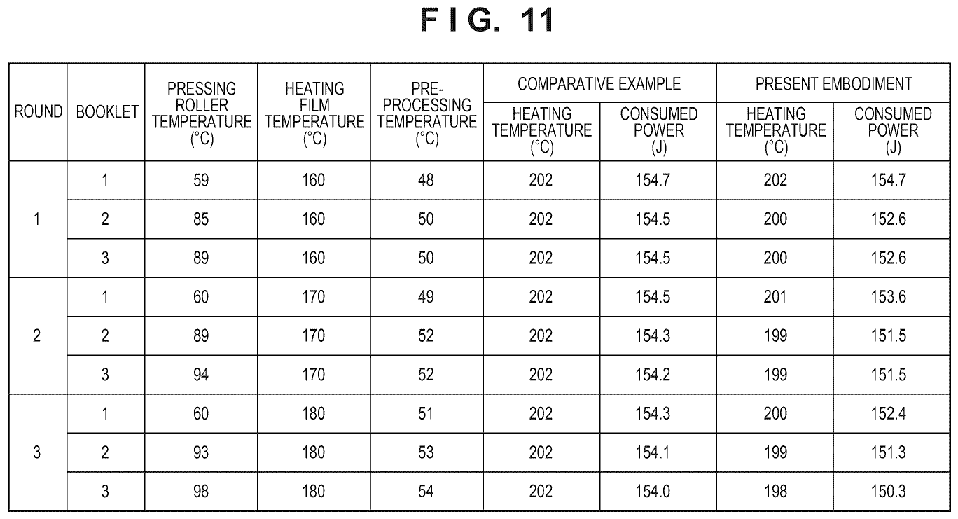

FIG. 11 illustrates an example of comparison of a case where the heating temperature in the bonding processing is set to be fixed and a case where the heating temperature in the bonding processing was controlled based on the details described in the present embodiment. In the experiment, three booklets, each with five sheets P, were created every five seconds, three times in total. At the start of each round, the temperature of the pressing roller 6c was set to 23° C., which is room temperature. In addition, the temperatures of the heating film 6b in the first, second, and third rounds were set to 160° C., 170° C., and 180° C., respectively. Further, the start-up duration of the fixing device 6 in each round was set to five seconds, and the duration of heating by the heating plate 502 was set to two seconds. The heating temperature in the comparative example was set to 202° C.

The pressing roller temperature of FIG. 11 indicates the temperature Tr of the pressing roller 6c estimated at a timing at which the fixing processing for the reference sheet is completed. The heating film temperature of FIG. 11 indicates the temperature of the heating film 6b estimated at a timing at which the fixing processing for the reference sheet is completed. Further, the pre-processing temperature of FIG. 11 indicates the pre-processing temperature of the reference sheet obtained according to Equation 5 from the temperature Tr of the pressing roller 6c and the temperature Tf of the heating film 6b. As indicated in FIG. 11, it is possible to reduce power consumption of the bonding processing as compared with that in which the heating temperature is fixed.

A configuration may be taken so as to, without using the temperature Tr of the pressing roller 6c, set the heating temperature to be lower as the temperature Tf of the heating film 6b is set to be higher. This is based on the pre-processing temperature of the reference sheet increasing as the temperature Tf of the heating film 6b is set to be higher. Further, in the present embodiment, the pre-processing temperature of a processing target sheet bundle can be set to be a value based on the pre-processing temperature of any one or more sheets P included in the processing target sheet bundle.

### Third Embodiment

Next, a third embodiment will be described focusing on differences from the first embodiment. In the present embodiment, the pre-processing temperature is evaluated using a temperature Tt of the secondary transfer roller 5, a temperature Tm of the conveyance path 46, and information on whether the image forming operation mode is single-sided mode or double-sided mode, in addition to the temperature Tr of the pressing roller 6c. The conveyance path 46 is a conveyance path that connects the fixing device 6 and the thermocompression bonding unit 51. The single-sided mode is an operation mode in which an image is formed only on one side of a sheet P, and the double-sided mode is an operation mode in which an image is formed on both sides of a sheet P. In the case of the single-sided mode, a sheet P is not conveyed through the double-sided conveyance path 36. Meanwhile, in the case of the double-sided mode, a sheet P on which the processing for fixing the image formed on the first surface is performed is conveyed through the double-sided conveyance path 36 for forming an image on the second surface, and then the fixing processing by the fixing device 6 is performed again.

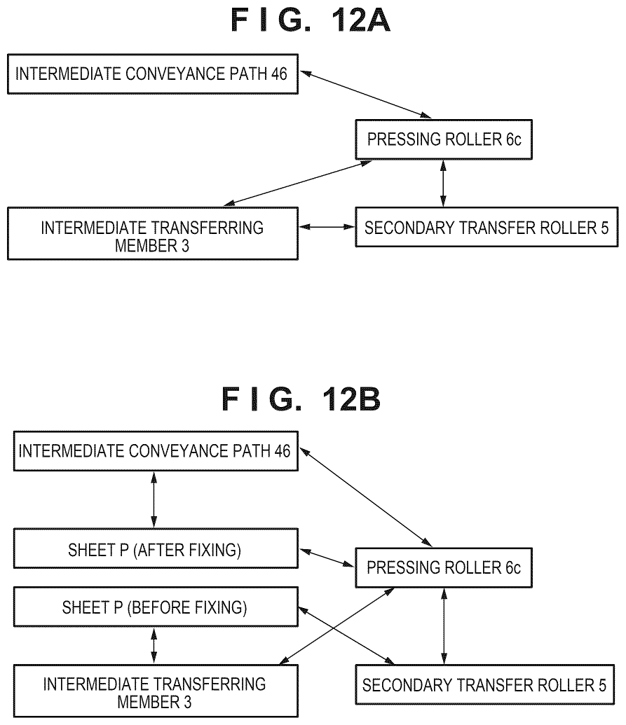

FIGS. 12A and 12B illustrate thermal conduction models for estimating the temperature Tt of the secondary transfer roller 5 and the temperature Tm of the conveyance path 46. FIG. 12A is a model for when the fixing processing for a sheet P is not being performed, and FIG. 12B is a model for when the fixing processing for a sheet P is being performed. In FIG. 12B, a “sheet P (before fixing)” indicates a sheet P for when an image is being transferred by the secondary transfer roller 5, and a “sheet P (after fixing)” indicates a sheet P passing through the nip region of the fixing device 6 and a sheet P fed to the conveyance path 46. A timing at which the sheet P passes through the conveyance path 46 and a timing at which the sheet P passes through the nip region of the fixing device 6 are different but are modeled as the same timing in FIG. 12B. This is because by assuming these to be the same timing, the model can be simplified. Further, since changes in temperatures of the conveyance path 46, the intermediate transfer body 3, and the secondary transfer roller 5 are more gradual than that of the pressing roller 6c, even if a timing at which the sheet P passes is slightly shifted, there will be no accuracy issues. However, the model can be set up with the timing at which the sheet P passes through the conveyance path 46 and the timing at which the sheet P passes through the nip region of the fixing device 6 being different.

The temperature Tm of the conveyance path 46 and the temperature Tt of the secondary transfer roller 5 at time t when the fixing processing is not being performed are estimated based on the following difference equation. In the following equation, the temperature of the intermediate transfer body 3 is set to be Tb.

$$\{ Tm ( t ) - Tm ( t - Δ t ) \} / Δ t = A 3 \{ Tm ( t - Δ t ) - Tr ( t - Δ t ) \} \qquad ( Equation 6 )$$

$$\{ Tb ( t ) - Tb ( t - Δ t ) \} / Δ t = A 4 \{ Tb ( t - Δ t ) - Tr ( t - Δ t ) \} + A 5 \{ Tb ( t - Δ t ) - Tt ( t - Δ t ) \} \qquad ( Equation 7 )$$

$$\{ Tt ( t ) - Tt ( t - Δ t ) \} / Δ t = A 6 \{ Tt ( t - Δ t ) - Tr ( t - Δ t ) \} + A 7 \{ Tt ( t - Δ t ) - Tb ( t - Δ t ) \} \qquad ( Equation 8 )$$

The temperature Tm of the conveyance path 46 and the temperature Tt of the secondary transfer roller 5 at time t when the fixing processing is not being performed are estimated based on the following difference equation. In the following equation, the temperature of a sheet P (before fixing) is set to be Tp, and the temperature of a sheet P (after fixing) is set to be Tpe.

$$\{ Tm ( t ) - Tm ( t - Δ t ) \} / Δ t = A 8 \{ Tm ( t - Δ t ) - Tr ( t - Δ t ) \} + A 9 \{ Tm ( t - Δ t ) - Tpe ( t - Δ t ) \} \qquad ( Equation 9 )$$

$$\{ Tpe ( t ) - Tpe ( t - Δ t ) \} / Δ t = A 10 \{ Tpe ( t - Δ t ) - Tr ( t - Δ t ) \} \qquad ( Equation 10 )$$

$$\{ Tb ( t ) - Tb ( t - Δ t ) \} / Δ t = A 11 \{ Tb ( t - Δ t ) - Tr ( t - Δ t ) \} + A 12 \{ Tb ( t - Δ t ) - Tp \} \qquad ( Equation 11 )$$

$$\{ Tt ( t ) - Tt ( t - Δ t ) \} / Δ t = A 13 \{ Tt ( t - Δ t ) - Tr ( t - Δ t ) \} + A 14 \{ Tt ( t - Δ t ) - Tp \} \qquad ( Equation 12 )$$

The coefficients A3 to A14 in the above equations can be obtained by experimentation. The temperature Tr of the pressing roller 6c is obtained as described in the first embodiment. Here, in the present embodiment, the temperature Tp of a sheet P is 23° C. at the time of formation for the first surface in the single-sided mode and in the double-sided mode. Further, at the time of formation for the second surface in the double-sided mode, an average value of the temperatures Tpe of sheets P (after fixing) during execution of the processing for fixing an image on the first surface is used.

The temperature of the conveyance path 46 increases due to heat from a sheet P on which the fixing processing has been performed. In the case of the double-sided mode, the temperatures of the intermediate transfer body 3 and the secondary transfer roller 5 increase due to heat from a sheet P on which the fixing processing for an image on the first surface has been performed. At the time of forming an image on the first surface in the single-sided mode or the double-sided mode, the intermediate transfer body 3 and the secondary transfer roller 5 do not change in temperature due to a sheet P having the same temperature as the environmental temperature or decrease in temperature due to heat being stolen by a sheet P.

Further, since heat received by a sheet P when passing through the conveyance path 46, the intermediate transfer body 3, and the secondary transfer roller 5 changes due to the temperature Tm, the temperature Tb, and the temperature Tt of those respective members changing, the temperature of the sheet P changes.

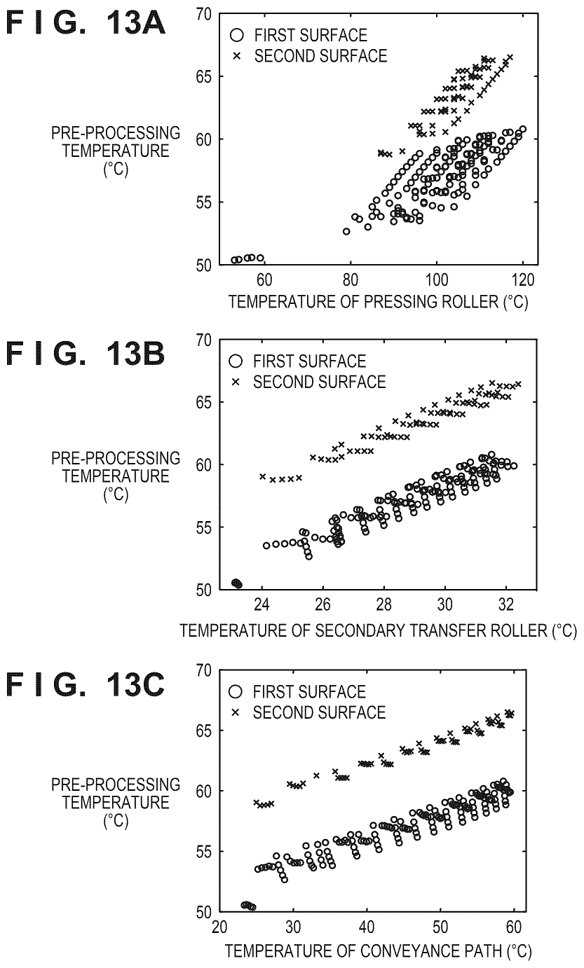

FIGS. 13A to 13C illustrate a relationship between the pre-processing temperature of the reference sheet and the temperature Tr of the pressing roller 6c estimated at a timing at which the fixing processing for the reference sheet is completed, the temperature Tt of the secondary transfer roller 5, and the temperature Tm of the conveyance path 46, respectively. ∘ in the figure indicates the temperature in the single-sided mode, and x indicates the temperature in the double-sided mode. Further, the temperature Tr, the temperature Tt, and the temperature Tm in the double-sided mode are values at the time of forming an image on the second surface.

Based on the results of FIGS. 13A to 13C, in the case of the single-sided mode, the pre-processing temperature Ta is determined based on Equation 13 below.

$$Ta = 0.0 \; 778 Tr + 0.1 \; 54 Tm + 0.0 \; 184 Tt + 41.709 \qquad ( Equation 13 )$$

Further, in the case of the double-sided mode, the pre-processing temperature Ta is determined based on Equation 14 below.

$$Ta = 0.0 \; 945 Tr + 0.0 \; 811 Tm + 0 \text{.341} Tt + 39.814 \qquad ( Equation 14 )$$

The reason why the temperature Tb of the intermediate transfer body 3 was not used as an evaluation value for the pre-processing temperature of the reference sheet is that its correlation coefficient with the temperature Tt of the secondary transfer roller is high at 0.99 and collinearity is strong. However, a configuration may be taken so as to also use the temperature Tb of the intermediate transfer body 3 as an evaluation value for the pre-processing temperature of the reference sheet. Also, instead of the temperature Tt of the secondary transfer roller, the temperature Tb of the intermediate transfer body 3 may be used as an evaluation value for the pre-processing temperature of the reference sheet.

A flowchart related to bonding processing according to the present embodiment is similar to that of FIG. 8. However, evaluation values for the pre-processing temperature of the reference sheet in step S13 are the temperature Tr of the pressing roller 6c, the temperature Tt of the secondary transfer roller 5, the temperature Tm of the conveyance path 46, and the operation mode (single-sided mode or double-sided mode). Regarding the temperatures Tr, Tm, and Tt used for evaluating the pre-processing temperature of the reference sheet, a temperature at a predetermined timing during execution of the fixing processing for an image formed on the second surface of the reference sheet can be used. For example, the predetermined timing can be a timing at which the processing for fixing an image formed on the second surface of the reference sheet is completed. Also, the temperatures Tr, Tm, and Tt used for evaluating the pre-processing temperature of the reference sheet can be set to be a statistical value, such as an average value, during execution of the fixing processing for an image formed on the second surface of the reference sheet.

In the present embodiment, the pre-processing temperature of the reference sheet can be accurately estimated even when the temperatures of the conveyance path 46 and the secondary transfer roller 5 change. When using the temperature of the intermediate transfer body 3 instead of the temperature of the secondary transfer roller 5, the above secondary transfer roller 5 need only be replaced with the intermediate transfer body 3. By being able to accurately estimate the pre-processing temperature, it is possible to appropriately control the amount of heat in the bonding processing, and thus, it is possible to reduce power consumption in the bonding processing.

### Comparison

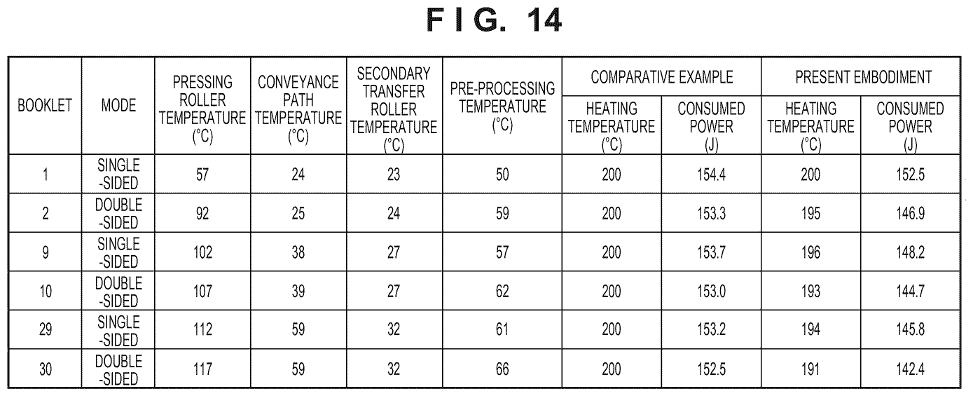

FIG. 14 illustrates an example of comparison of a case where the heating temperature in the bonding processing is set to be fixed and a case where the heating temperature was controlled according to the details described in the present embodiment. In the experiment, 30 booklets, each with 5 sheets P, was prepared every 5 seconds, with the start-up duration of the fixing device 6 set to 5 seconds. The single-sided mode and the double-sided mode were switched for each booklet. Further, in each round, the duration of heating by the heating plate 502 was 2 seconds. The heating temperature in the comparative example was set to 200° C.

FIG. 14 illustrates the results for the first, second, ninth, 10th, 29th and 30th booklets. The pressing roller temperature, the conveyance path temperature, and the secondary transfer roller temperature of FIG. 14 respectively indicate the temperature Tr of the pressing roller 6c estimated at a timing at which the fixing processing for the reference sheet is completed, the temperature Tm of the conveyance path 46, and the temperature Tt of the secondary transfer roller 5. The pre-processing temperature of FIG. 14 indicates the pre-processing temperature of the reference sheet determined based on Equation 13 or 14. As indicated in FIG. 14, it is possible to reduce power consumption of the bonding processing as compared with that in which the heating temperature is fixed.

A configuration may be taken so as to set the heating temperature to be lower as the estimated temperature Tm of the conveyance path 46 increases, or a configuration may be taken so as to set the heating temperature to be lower as the estimated temperature Tt of the secondary transfer roller 5 (or the intermediate transfer body 3) increases. This is based on the pre-processing temperature of the reference sheet increasing as the temperature Tm of the conveyance path 46 and the temperature Tt of the secondary transfer roller 5 (or the intermediate transfer body 3) increase. Further, a configuration may be taken so as to set the heating temperature in the case of the double-sided mode to be lower than the heating temperature in the case of the single-sided mode. This is based on the pre-processing temperature of the reference sheet being higher in the double-sided mode than in the single-sided mode.

In the present embodiment, temperatures during execution of the fixing processing for the reference sheet are assumed as the temperature Tr, the temperature Tt, and the temperature Tm to be used as evaluation values for the pre-processing temperature of the reference sheet. This is based on usage of the models of FIGS. 12A and 12B. However, the temperature of the secondary transfer roller 5 (or the intermediate transfer body 3) to be used as an evaluation value for the pre-processing temperature of the reference sheet may be a temperature at a predetermined timing while an image is being transferred to the second surface of the reference sheet by the secondary transfer roller 5. Similarly, the temperature Tm of the conveyance path 46 may be a temperature at a timing at which the reference sheet is passing a predetermined position of the conveyance path 46. In other words, the temperature of a member to be used as an evaluation value for the reference sheet can be the temperature of that member at a timing at which that member and the reference sheet are in contact.

The thermal conduction models illustrated in FIGS. 12A and 12B are only examples, and other thermal conduction models can be used to determine the temperature of each member. Further, a configuration may be taken so as to provide a temperature sensor for measuring the temperature of each member and use the measured value of the temperature of each member.

Further, as described in the second embodiment, a configuration may be taken so as to use the temperature Tf of the heating film 6b as an evaluation value for the pre-processing temperature of the reference sheet. That is, the temperature of the heating film 6b can be additionally used to evaluate the pre-processing temperature of the reference sheet. Further, in the present embodiment, the pre-processing temperature of a processing target sheet bundle can be set to be a value based on the pre-processing temperature of any one or more sheets P included in the processing target sheet bundle.

### Fourth Embodiment

Next, a fourth embodiment will be described focusing on differences from the first embodiment. In the first embodiment, the temperature Tr of the pressing roller 6c is assumed as an evaluation value for the pre-processing temperature. In the present embodiment, in addition to the temperature Tr of the pressing roller 6c, an environmental temperature Te measured by the temperature sensor 60 is used.

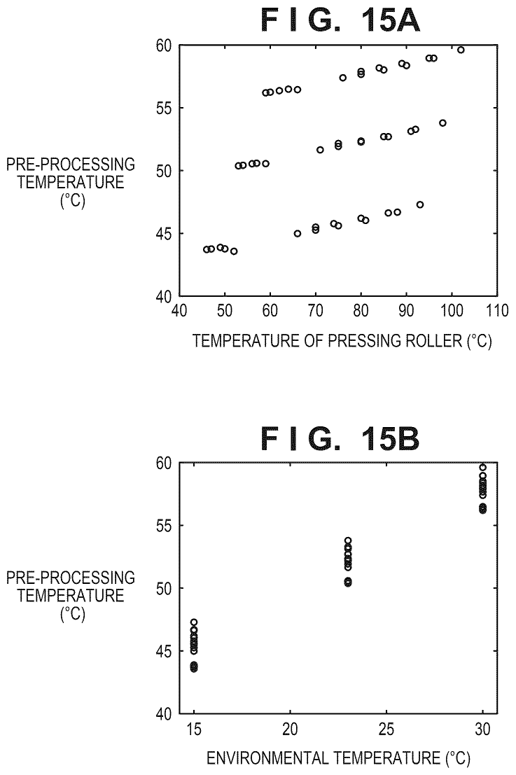

When the environmental temperature (room temperature) changes, the temperature of a sheet P stored in the cassette 8 changes, and the pre-processing temperature also changes accordingly. FIGS. 15A and 15B illustrate results of an experiment in which the pre-processing temperature was measured in different environmental temperatures Te. In the experiment, an experiment in which three booklets, each with five sheets P, were created every five seconds was carried out three times in total. The environmental temperatures Te of respective rounds were set to 15° C., 23° C., and 30° C., respectively. At the start of each round, the temperature of the pressing roller 6c was set to the environmental temperature. The other conditions were the same in each round.

FIG. 15A illustrates a relationship between the temperature Tr of the pressing roller estimated at a timing at which the fixing processing for the reference sheet is completed and the pre-processing temperature, and FIG. 15B illustrates a relationship between the environmental temperature Te and the pre-processing temperature. Based on the results of FIGS. 15A and 15B, the pre-processing temperature Ta is determined based on Equation 15 below.

$$Ta = 0.0 \; 770 Tr + 0.7 \; 74 Tf + 28.362 \qquad ( Equation 15 )$$

A flowchart related to bonding processing according to the present embodiment is similar to that of FIG. 8. However, evaluation values for pre-processing temperature of the reference sheet in step S13 are the temperature Tr of the pressing roller 6c for when fixing processing for the reference sheet is completed and the environmental temperature Te. Regarding the environmental temperature Te to be used as an evaluation value for the pre-processing temperature of the reference sheet, since a change in the environmental temperature Te is gradual, a value at any timing from feeding of the reference sheet to execution of the bonding processing can be used.

In the present embodiment, the pre-processing temperature can be accurately estimated even when the environmental temperature Te changes, and therefore, the amount of heat in the bonding processing can be appropriately controlled. Therefore, it is possible to reduce power consumption in the bonding processing.

### Comparison

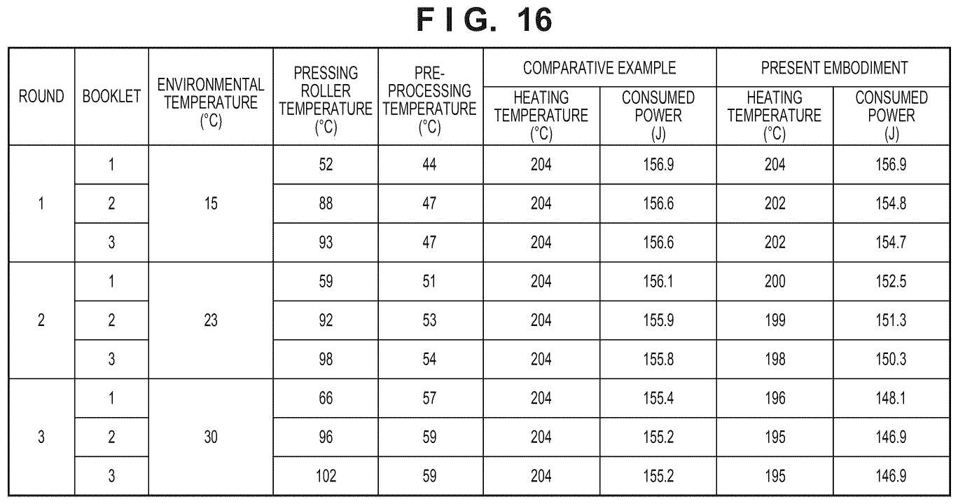

FIG. 16 illustrates an example of comparison of a case where the heating temperature in the bonding processing is set to be fixed and a case where the heating temperature was controlled based on the details described in the present embodiment. In the experiment, threes booklets, each with five sheets P, were created every five seconds, three times in total. The environmental temperatures Te of respective rounds were set to 15° C., 23° C., and 30° C., respectively. At the start of each round, the temperature of the pressing roller 6c was set to the environmental temperature. The other conditions were the same in each round. The heating temperature in the comparative example was set to 204° C.

The pressing roller temperature of FIG. 16 indicates the temperature Tr of the pressing roller 6c estimated at a timing at which the fixing processing for the reference sheet is completed. Further, the pre-processing temperature of FIG. 16 indicates a value determined according to Equation 15 based on the temperature Tr of the pressing roller 6c and the environmental temperature Te. As indicated in FIG. 16, it is possible to reduce power consumption of the bonding processing as compared with that in which the heating temperature is fixed.

A configuration may be taken so as to, without using the temperature Tr of the pressing roller 6c, set the heating temperature to be lower as the environmental temperature Te increases. This is based on the pre-processing temperature of the reference sheet increasing as the environmental temperature Te increases. Further, as described in the third embodiment, the temperature of the heating film 6b, the temperature of the secondary transfer roller 5, the temperature Tm of the conveyance path 46, the temperature of the intermediate transfer body 3, and the operation mode (single-sided/double-sided) can be additionally used as evaluation values for the pre-processing temperature of the reference sheet.

### Fifth Embodiment

Next, a fifth embodiment will be described focusing on differences from the first embodiment. In the first embodiment, the temperature Tr of the pressing roller 6c is assumed as an evaluation value for the pre-processing temperature. In the present embodiment, in addition to the temperature Tr of the pressing roller 6c, processing speed is used.

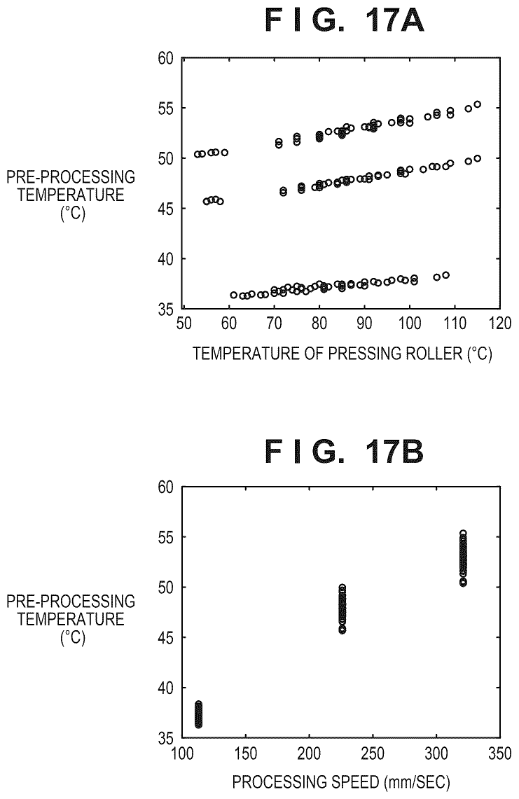

The processing speed is a value indicating the speed of image formation, and as the processing speed increases, the conveyance speed of a sheet P and the rotation speed of the intermediate transfer body 3 increases. Here, a sheet P is cooled due to heat being stolen by the conveyance path 46 when passing through the conveyance path 46. The slower the processing speed, the longer the time it takes to pass through the conveyance path 46, and thus, the pre-processing temperature decreases. FIGS. 17A and 17B illustrate results of an experiment in which the pre-processing temperature was measured at different processing speeds Vp. In the experiment, an experiment in which three booklets, each with five sheets P, were created every five seconds was carried out three times in total. The processing speeds Vp for respective rounds were set at 321 mm/second, 226 mm/second and 113 mm/second, respectively. At the start of each round, the temperature of the pressing roller 6c was set to the environmental temperature. The other conditions were the same in each round.

FIG. 17A illustrates a relationship between the temperature Tr of the pressing roller estimated at a timing at which the fixing processing for the reference sheet is completed and the pre-processing temperature, and FIG. 17B illustrates a relationship between the processing speed Vp and the pre-processing temperature. Based on the results of FIGS. 17A and 17B, in the case of the processing speed of 321 mm/second, the pre-processing temperature Ta is determined based on Equation 16 below.

$$Ta = 0.0 \; 789 Tr + 45.9 \qquad ( Equation 16 )$$

In the case of the processing speed of 226 mm/second, the pre-processing temperature Ta is determined based on Equation 17 below.

$$Ta = 0.0 \; 700 Tr + 41.7 \qquad ( Equation 17 )$$

Further, in the case of the processing speed of 113 mm/second, the pre-processing temperature Ta is determined based on Equation 18 below.

$$Ta = 0.0 \; 415 Tr + 33.8 \qquad ( Equation 18 )$$

A flowchart related to bonding processing according to the present embodiment is similar to that of FIG. 8. However, evaluation values for the pre-processing temperature of the reference sheet in step S13 are the temperature Tr of the pressing roller 6c and the processing speed Vp.

In the present embodiment, the pre-processing temperature can be accurately estimated even when the processing speed Vp changes, and therefore, the amount of heat in the bonding processing can be appropriately controlled. Therefore, it is possible to reduce the power consumption in the bonding processing.

### Comparison

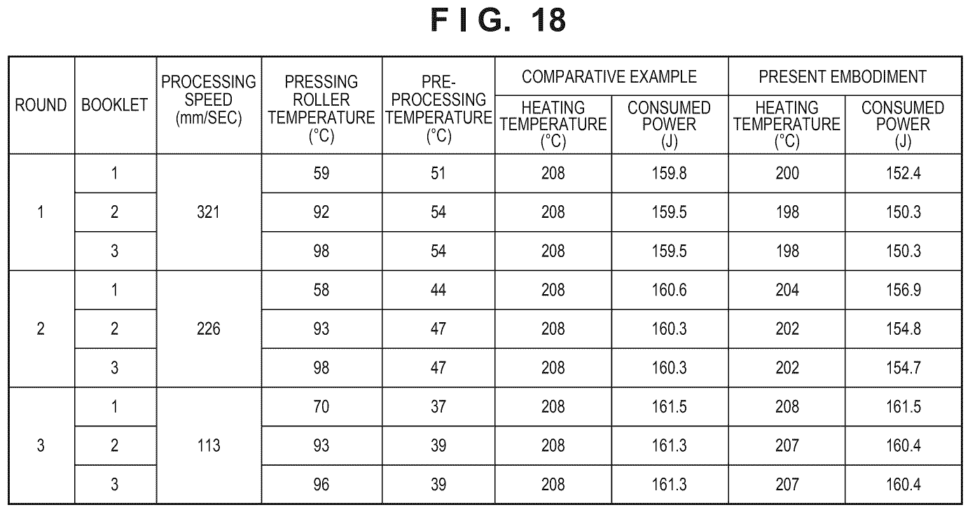

FIG. 18 illustrates an example of comparison of a case where the heating temperature in the bonding processing is set to be fixed and a case where the heating temperature was controlled based on the details described in the present embodiment. In the experiment, three booklets, each with five sheets P, were created every five seconds, three times in total. The processing speeds Vp for respective rounds were set at 321 mm/second, 226 mm/second and 113 mm/second, respectively. At the start of each round, the temperature of the pressing roller 6c was set to the environmental temperature. The other conditions were the same in each round. The heating temperature in the comparative example was set to 208° C.

The pressing roller temperature of FIG. 18 indicates the temperature Tr of the pressing roller 6c estimated at a timing at which the fixing processing for the reference sheet is completed. In addition, pre-processing temperature of FIG. 18 indicates the pre-processing temperature obtained according to Equations 16 to 18. As indicated in FIG. 18, it is possible to reduce power consumption of the bonding processing as compared with that in which the heating temperature is fixed.

A configuration may be taken so as to, without using the temperature of the pressing roller 6c, set the heating temperature to be lower as the processing speed increases. This is based on the pre-processing temperature of the reference sheet increasing as the processing speed increases. Further, as described in the fourth embodiment, the temperature of the heating film 6b, the temperature of the secondary transfer roller 5, the temperature Tm of the conveyance path 46, the temperature of the intermediate transfer body 3, the operation mode (single-sided/double-sided), and the environmental temperature can be additionally used as evaluation values for the pre-processing temperature of the reference sheet.

As described in each of the above embodiments, at the time of bonding processing, a temperature of the plurality of sheets P to be subjected to bonding processing is evaluated, and based on the evaluated temperature, the amount of heat to be applied to the plurality of sheets P in bonding processing is controlled. With this configuration, it is possible to prevent an unnecessary amount of heat from being applied to the sheets P and thus reduce power consumption in the bonding processing. The amount of heat to be applied to the plurality of sheets P is reduced as the evaluated temperature increases.

As the temperature of the plurality of sheets P, a temperature of a predetermined sheet among the plurality of sheets P at the time of bonding processing can be used. Here, the predetermined sheet may be a sheet in a position farthest from the heating plate 502 among the plurality of sheets P. The plurality of sheets P correspond to the processing target sheet bundle in the above embodiments.

As described in the first embodiment, a configuration may be taken so as to evaluate the temperature of the predetermined sheet based on the result of measurement of the temperature of the predetermined sheet after the fixing processing has been performed in the fixing device 6. Further, as described in the first embodiment, a configuration may be taken so as to evaluate the temperature of the predetermined sheet based on the start-up duration. Further, as described in the above embodiments, the temperature of the predetermined sheet can be evaluated using one or more of the temperatures of the pressing roller 6c, the heating film 6b, the secondary transfer roller 5, the conveyance path 46, and the intermediate transfer body 3, the environmental temperature, the processing speed, the operation mode (single-sided/double-sided), and the start-up duration.

The pressing roller 6c, the heating film 6b, the secondary transfer roller 5, the conveyance path 46, and the intermediate transfer body 3 are examples of a member in which thermal conduction occurs with a sheet P. Therefore, the temperature of the predetermined sheet can be evaluated based on the temperature of at least one or more members in which thermal conduction occurs with a sheet P, and some embodiments are not limited to using the members listed above.

The temperature of one or more members used to evaluate the temperature of the predetermined sheet can be the temperature of a member for when that member and the predetermined sheet are in contact. Further, in the case of a member in which a change in temperature is gradual, it is also possible to use a temperature at a predetermined timing at which that member and the predetermined sheet are not in contact. As an example, the temperature of one or more members at a predetermined timing while the fixing processing for the predetermined sheet by the fixing device 6 is being performed can be used to evaluate the temperature of the predetermined sheet. Also, a temperature at a predetermined timing from when the fixing processing is performed until when the bonding processing is performed can be used.

It is not necessary to determine the temperature, at the time of bonding processing, of the predetermined sheet among the plurality of sheets P to be subjected to the bonding processing. That is, a configuration may be taken so as to store, in the control unit 100, determination information indicating a relationship between one or more parameter values among one or more members in which thermal conduction occurs with a sheet P, the environmental temperature, the processing speed, the operation mode (single-sided/double-sided), and the start-up duration, and the amount of heat to be applied to the plurality of sheets P in the bonding processing, and control the amount of heat based on the parameter values and the determination information.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-000305, which was filed on Jan. 4, 2024 and which is hereby incorporated by reference herein in its entirety.

What is claimed is:

1. An image forming apparatus comprising:
an image forming unit configured to form an image including an adhesive image by powder adhesive on a sheet that is conveyed;
a bonding unit, to which sheets on which the image has been formed by the image forming unit are conveyed in order, configured to, by heating a plurality of sheets conveyed to and stacked in the bonding unit, bond the plurality of sheets, using adhesive images formed on the plurality of sheets; and
a control unit configured to evaluate a temperature of the plurality of sheets conveyed to the bonding unit and, based on the evaluated temperature, control an amount of heat to be applied to the plurality of sheets by the bonding unit heating the plurality of sheets.

2. The image forming apparatus according to claim 1, wherein
the control unit decreases the amount of heat as the evaluated temperature increases.

3. The image forming apparatus according to claim 1, wherein
the image forming unit includes:
a transfer unit configured to transfer the image to the sheet; and
a fixing device including a heating member configured to heat the sheet and a pressing member configured to press the sheet, and configured to, by heating and pressing the sheet, perform fixing processing for fixing, to the sheet, the image transferred to the sheet,
the image forming apparatus includes a first temperature sensor configured to measure a temperature of the sheet after the fixing processing has been performed by the fixing device, and
the control unit is configured to evaluate the temperature of the plurality of sheets based on a result of measurement by the first temperature sensor.

4. The image forming apparatus according to claim 1, wherein
the image forming unit includes:
a transfer unit configured to transfer the image to the sheet; and
a fixing device including a heating member configured to heat the sheet and a pressing member configured to press the sheet, and configured to, by heating and pressing the sheet, perform fixing processing for fixing, to the sheet, the image transferred to the sheet, and
the control unit is configured to evaluate the temperature of the plurality of sheets based on a temperature of the pressing member.

5. The image forming apparatus according to claim 1, wherein
the image forming unit includes:
a transfer unit configured to transfer the image to the sheet; and
a fixing device including a heating member configured to heat the sheet and a pressing member configured to press the sheet, and configured to, by heating and pressing the sheet, perform fixing processing for fixing, to the sheet, the image transferred to the sheet, and
the control unit is configured to evaluate the temperature of the plurality of sheets based on a duration in which the fixing device heats the heating member before starting the fixing processing on the plurality of sheets.

6. The image forming apparatus according to claim 1, wherein
the image forming unit includes:
a transfer unit configured to transfer the image to the sheet; and
a fixing device including a heating member configured to heat the sheet and a pressing member configured to press the sheet, and configured to, by heating and pressing the sheet, fix, to the sheet, the image transferred to the sheet, and
the control unit is configured to evaluate the temperature of the plurality of sheets based on a temperature of the heating member.

7. The image forming apparatus according to claim 1, wherein
the image forming unit includes:
a transfer unit configured to transfer the image formed on an intermediate transfer body to the sheet; and
a fixing device including a heating member configured to heat the sheet and a pressing member configured to press the sheet, and configured to, by heating and pressing the sheet, fix, to the sheet, the image transferred to the sheet,
the image forming apparatus includes a conveyance path connecting the fixing device and the bonding unit, and operates in either operation mode among a single-sided mode in which an image is formed only on one side of the sheet and a double-sided mode in which an image is formed on both sides of the sheet, and
the control unit is configured to evaluate the temperature of the plurality of sheets based on at least one among a temperature of the intermediate transfer body, a temperature of the transfer unit, a temperature of the conveyance path, and the operation mode.

8. The image forming apparatus according to claim 1, further comprising:
a second temperature sensor configured to measure an environmental temperature,
wherein the control unit is configured to evaluate the temperature of the plurality of sheets based on the environmental temperature.

9. The image forming apparatus according to claim 1, wherein
the control unit is configured to evaluate the temperature of the plurality of sheets based on a conveyance speed of the sheet.

10. The image forming apparatus according to claim 6, wherein
the control unit is configured to evaluate the temperature of the plurality of sheets further based on a temperature of the pressing member.

11. The image forming apparatus according to claim 8, wherein
the image forming unit includes:
a transfer unit configured to transfer the image to the sheet; and
a fixing device including a heating member configured to heat the sheet and a pressing member configured to press the sheet, and configured to, by heating and pressing the sheet, fix, to the sheet, the image transferred to the sheet, and
the control unit is configured to evaluate the temperature of the plurality of sheets further based on a temperature of the pressing member.

12. The image forming apparatus according to claim 1, wherein
the control unit is configured to evaluate a temperature of a reference sheet among the plurality of sheets.

13. The image forming apparatus according to claim 12, wherein
the bonding unit includes a heater,
the control unit is configured to, when a predetermined number of sheets among a plurality of sheets constituting one booklet has been conveyed to and stacked in the bonding unit and when a last sheet among the plurality of sheets constituting the one booklet has been conveyed to and stacked in the bonding unit, perform bonding processing for bonding the plurality of sheets stacked in the bonding unit heating the plurality of sheets by the heater, and
the reference sheet is a sheet positioned farthest from the heater among one or more sheets that are stacked in the bonding unit and have not been heated by the heater.

14. An image forming apparatus comprising:
an image forming unit configured to form an image including an adhesive image by powder adhesive on a sheet that is conveyed;
a bonding unit to which sheets on which the image has been formed by the image forming unit are conveyed in order, and configured to, by heating a plurality of sheets conveyed to and stacked in the bonding unit, bond the plurality of sheets, using adhesive images formed on the plurality of sheets; and
a control unit configured to control an amount of heat that the bonding unit applies to the plurality of sheets by heating the plurality of sheets,
wherein the control unit is configured to control the amount of heat to be applied to the plurality of sheets, based on a temperature of at least one member in which thermal conduction occurs with the sheet or an environmental temperature.

15. The image forming apparatus according to claim 14, wherein
the image forming unit includes:
a transfer unit configured to transfer the image formed on an intermediate transfer body to the sheet; and
a fixing device including a heating member configured to heat the sheet and a pressing member configured to press the sheet, and configured to, by heating and pressing the sheet, perform fixing processing for fixing, to the sheet, the image transferred to the sheet,
the image forming apparatus includes a conveyance path connecting the fixing device and the bonding unit, and
the at least one member includes at least one among the heating member, the pressing member, the intermediate transfer body, the transfer unit, and the conveyance path.

16. The image forming apparatus according to claim 14, wherein
the control unit is configured to control the amount of heat to be applied to the plurality of sheets, based on a temperature of the at least one member for when a reference sheet among the plurality of sheets is in contact with the at least one member.

17. The image forming apparatus according to claim 15, wherein
the control unit is configured to control the amount of heat to be applied to the plurality of sheets, based on a temperature of the at least one member for when fixing processing on a reference sheet among the plurality of sheets is completed.

18. The image forming apparatus according to claim 17, wherein
the bonding unit includes a heater,
the control unit is configured to, when a predetermined number of sheets among a plurality of sheets constituting one booklet has been conveyed to and stacked in the bonding unit and when a last sheet among the plurality of sheets constituting the one booklet has been conveyed to and stacked in the bonding unit, perform bonding processing for bonding the plurality of sheets stacked in the bonding unit by heating the plurality of sheets by the heater, and
the reference sheet is a sheet positioned farthest from the heater among one or more sheets that are stacked in the bonding unit and have not been heated by the heater.

19. The image forming apparatus according to claim 14, wherein
the control unit is configured to decrease the amount of heat to be applied to the plurality of sheets as the temperature of the at least one member increases.

20. The image forming apparatus according to claim 14, wherein
the control unit is configured to decrease the amount of heat to be applied to the plurality of sheets as the environmental temperature increases.

21. An image forming apparatus comprising:
an image forming unit configured to form an image including an adhesive image by powder adhesive on a sheet that is conveyed;
a bonding unit to which sheets on which the image has been formed by the image forming unit are conveyed in order, and configured to, by heating a plurality of sheets conveyed to and stacked in the bonding unit, bond the plurality of sheets, using adhesive images formed on the plurality of sheets; and
a control unit configured to control an amount of heat that the bonding unit applies to the plurality of sheets by heating the plurality of sheets,
wherein the control unit is configured to control the amount of heat to be applied to the plurality of sheets, based on a conveyance speed of the sheet or in which operation mode among a single-sided mode in which an image is formed only on one side of the sheet and a double-sided mode in which an image is formed on both sides of the sheet operation is being performed.

22. The image forming apparatus according to claim 21, wherein
the control unit is configured to decrease the amount of heat to be applied to the plurality of sheets as the conveyance speed increases.

23. The image forming apparatus according to claim 21, wherein
the control unit is configured to, in a case where operation is being performed in the double-sided mode, decrease the amount of heat to be applied to the plurality of sheets than in a case where operation is being performed in the single-sided mode.

24. An image forming apparatus comprising:
an image forming unit configured to form an image including an adhesive image by powder adhesive on a sheet that is conveyed;
a bonding unit to which sheets on which the image has been formed by the image forming unit are conveyed in order, and configured to, by heating a plurality of sheets conveyed to and stacked in the bonding unit, bond the plurality of sheets, using adhesive images formed on the plurality of sheets; and
a control unit configured to control an amount of heat to be applied to the plurality of sheets by the bonding unit heating the plurality of sheets,
wherein
the image forming unit includes:
a transfer unit configured to transfer the image to the sheet; and
a fixing device including a heating member configured to heat the sheet and a pressing member configured to press the sheet, and configured to, by heating and pressing the sheet, perform fixing processing for fixing, to the sheet, the image transferred to the sheet, and
the control unit is configured to control the amount of heat to be applied to the plurality of sheets based on a duration in which the fixing device heats the heating member before starting the fixing processing on the plurality of sheets.

25. The image forming apparatus according to claim 24, wherein
the control unit is configured to decrease the amount of heat to be applied to the plurality of sheets as the duration in which the fixing device heats the heating member before starting the fixing processing on the plurality of sheets increases.

26. The image forming apparatus according to claim 1, wherein
the control unit is configured to control the amount of heat to be applied to the plurality of sheets by controlling one or both among a heating duration in which the bonding unit heats the plurality of sheets and a heating temperature in the heating duration.

27. The image forming apparatus according to claim 1, wherein
the powder adhesive is toner also used for forming an image different from the adhesive image.
